(19) United States
(12) Patent Application Publication
(10) Pub. No.: US 2006/0210703 A1
(43) Pub. Date: Sep. 21, 2006

(54) Method for manufacturing protrusions

(75) Inventors: Shoichi Suda, Kawasaki (JP); Keiji Watanabe, Kawasaki (JP); Hiroshi Inoue, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/242,941

(22) Filed: Oct. 5, 2005

(30) Foreign Application Priority Data
Mar. 17, 2005 (JP) 2005-77145
Jul. 1, 2005 (JP) 2005-194228

(51) Int. Cl. B05D 5/12; C08F 2/46; B05D 5/00; B05D 3/12

(52) U.S. Cl. 427/64; 427/282; 427/487; 427/355

(57) ABSTRACT

Provided are technologies for manufacturing protrusions having various properties better than the conventional technologies. The protrusions are manufactured by the steps comprising: filling a specific composition into slits by means of a squeegee printing method; curing the photosensitive resin in the composition by light exposure to make a cured composition from the composition; and firing the cured composition. These protrusions preferably have a relative dielectric constant of less than 4.0 and a difference in linear expansion coefficient of not more than 4 ppm/° C., based on the linear expansion coefficient of a dielectric layer material for use.

### CROSS-REFERENCE TO RELATED APPLICATIONS

This application is based upon and claims the benefit of priority from the prior Japanese Patent Applications No. 2005-077145, filed on Mar. 17, 2005, and No. 2005-194228, filed on Jul. 1, 2005, the entire contents of which are incorporated herein by reference.

### BACKGROUND OF THE INVENTION

1. Field of the Invention

The present invention relates to a method for manufacturing protrusions that can be used as partitioning walls (ribs) or the like of display panels including plasma display panels (PDPs), and plasma addressed liquid crystal display (PALCD) panels, for example.

2. Description of the Related Art

Display panels such as PDPs and PALCD panels are known as thin display panels having partitioning walls.

Among them, PDPs are thin display devices that are excellent in visibility, can realize a high-speed display, and can be relatively easily made to have large screens, and accordingly, are widely used for applications such as high-quality television sets, OA machines, and public information display devices. As the applications are expanding, attention has focused on color PDPs that have multitudes of tiny display cells.

PDPs realize display in visible rays, for example, by applying voltage between pairs of display electrodes to generate electric discharge, which is then used to excite the ultraviolet ray-emitting gas contained in the electric discharge spaces into a plasma state, and making phosphors in the phosphor layers emit light by means of the ultraviolet rays that are generated when the gas returns from the plasma state to the original state. In this case, the electric discharge spaces separated from each other by partitioning walls (also called insulating walls or ribs) were installed in order to restrain the extent of the electric discharge in certain areas, and secure uniform discharging.

As methods for forming such partitioning walls of PDPs, known are a sand blast method by which a pattern for partitioning walls is formed by photolithography on the layer of a material for forming partitioning walls (partitioning wall forming material) comprising a low melting point, lead glass, and the partitioning walls are formed by bombarding the pattern with a blast material, an additive method by which a pattern is formed on a substrate, the pattern having hollow locations where the partitioning walls are to be formed, a partitioning wall forming material is filled into the hollow locations, and then, the partitioning walls are formed by removing the pattern, and a multilayer printing method by which partitioning walls are formed by repeating screen printing or the like {see Japanese Unexamined Patent Application Publication No. H11-306965 (claims)}.

Meanwhile, a process with high yield and high efficiency in material utilization is required in the manufacturing of PDPs in recent years to respond to the request for lower cost. A high-level precision in shape control is also required from the viewpoint of panel properties. Furthermore, disuse of lead-containing materials is required for the purpose of reducing the burden on the environment. Accordingly, establishment of a process that is simplified, provides a high material utilization efficiency, makes a high level of shape control possible, and does not use any lead-containing material, is needed.

However, among the above-described conventional methods for forming partitioning walls, the sandblast method cannot be regarded as a favorable method in terms of material utilization efficiency, since it generates a large amount of waste materials. The additive method requires advanced patterning technologies, and a lot of time and work. Furthermore, the multilayer printing method is far from being sufficient in terms of shape control. On top of these, the conventional partitioning wall forming materials have a problem of burden on the environment, since they contain low melting point lead glass.

Thus, the method for forming partitioning walls that is sufficient in material utilization efficiency, shape control, burden on the environment or cost, has not been established among the conventional methods for forming partitioning walls.

Furthermore, methods in which the partitioning walls are formed by photolithography and using partitioning wall forming materials have been proposed {see Japanese Unexamined Patent Application Publication Nos. H1-296534 (claims), H2-165538 (claims), H5-342992 (claims), H6-295676 (claims) and H8-50811 (claims)}. However, in these cases, when thinner line widths are chosen to have a larger aperture ratio for improving the luminance, there would be problems of possible false discharge when certain types of glasses are used, higher discharge voltage and larger amount of electric power consumed. Furthermore, since photosensitive components and binder components that are used for these technologies are organic materials, there is a problem of a large coefficient of thermal contraction (thermal shrinkage) of more than 10% by firing that will result in thermal deformation and peeling-off of the partitioning wall pattern, when certain partitioning wall patterns are used.

These are problems in common with gas discharge panels including PALCD panels, etc.

### SUMMARY OF THE INVENTION

Accordingly, it is an object of the present invention to solve the above-described problems, and provide protrusion forming technologies that are better than the conventional methods in some or all of the points of material utilization efficiency, shape control, costs, manufacturing precision affected by physical properties of materials such as thermal shrinking, process yield, electric power consumption, and impact on environment (conventionally lead is used). Other objects and advantages of the present invention will be explained in the following explanation.

According to one aspect of the present invention, provided is a method for manufacturing protrusions comprising: attaching closely to a substrate one side of a mask on which a multitude of elongated slits are formed; filling a composition comprising a negative-type photosensitive, tetrafunctional siloxane type resin and a lead-free glass powder into the slits by means of a squeegee printing method; curing the photosensitive resin by light exposure to make a cured composition from the composition; removing the mask; and firing the cured composition adhered to the substrate.

According to another aspect of the present invention, provided is a method for manufacturing protrusions comprising: attaching onto a dielectric layer on a substrate a composition comprising a photosensitive resin and a lead-free glass powder; curing the photosensitive resin by light exposure to make a cured composition from the composition; and firing the cured composition, wherein the coefficient of thermal contraction by the firing of the protrusions is not more than 10%, and the protrusions have a relative dielectric constant of less than 4.0 at 1 kHz and 20° C. and a difference in linear expansion coefficient of not more than 4 ppm/° C., based on the dielectric material.

By these aspects, protrusion forming technologies are realized that are better than the conventional methods in some or all of the points of material utilization efficiency, shape control, costs, manufacturing precision affected by physical properties of materials such as thermal shrinking, process yield, electric power consumption, and impact on environment (use of lead). These protrusions can be used as partitioning walls of display panels such as plasma display panels.

Regarding the second aspect, preferable are that one side of a mask on which a multitude of elongated slits are formed, is attached closely to the dielectric layer, the composition is filled into the slits by means of a squeegee printing method, the mask is removed after the light exposure, and the cured composition adhered to the dielectric layer was fired; that the composition comprises a negative-type photosensitive, tetrafunctional siloxane type resin; and that the composition further comprises silica.

Also, commonly preferable for the above-described two aspects are that the negative-type photosensitive, tetrafunctional siloxane type resin has a structure represented by formula (1),
(SiO_{4/2})ₘ(R¹SiO_{3/2})ₙ(R²R³SiO_{2/2})ₚ(R⁴R⁵R⁶SiO_{1/2})_{q} (1)
(wherein m and q are each a positive integer; n and p are each 0 or a positive integer; and R¹ to R⁶ are, independently from each other, hydrogen or an organic group that may be bound to Si in which not all of R¹ to R⁶ are hydrogen); that the organic group comprises an aromatic hydrocarbon-containing group; that the aromatic hydrocarbon-containing group comprises a structural part represented by formula (2), 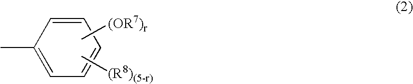
(wherein R⁷ and R⁸ are, independently from each other, hydrogen or an organic group that may be bound to Si; and r is 1 or 2); and that the composition comprises a solvent so that 0.5 to 10 wt. % of the solvent is present in the composition at the light exposure.

By the present invention, there are provided technologies for manufacturing protrusions that are better than the conventional methods in some or all of the points of material utilization efficiency, shape control, costs, manufacturing precision affected by physical properties of materials such as thermal shrinking, process yield, electric power consumption, and impact on environment (use of lead). These protrusions may be used as partitioning walls of display panels including plasma display panels.

### BRIEF DESCRIPTION OF THE DRAWINGS

FIG. 1 is an exploded view of an exemplary PDP;

FIG. 2 is a side cross-sectional view of a PDP in FIG. 1;

FIG. 3 shows examples of bonds included in the structure represented by formula (1);

FIG. 4 shows other examples of bonds included in the structure represented by formula (1);

FIG. 5 is a schematic view showing an example of a mask for use in a method for manufacturing partitioning walls of a display panel according to the present invention;

FIG. 6 is a schematic view showing the positional relationship between a mask and a substrate when partitioning walls are formed on the substrate;

FIG. 7 is a schematic perspective view showing a structure of an AC-driving, three-electrode, area discharging type PDP; and

FIG. 8 is a schematic view showing steps for manufacturing partitioning walls according to the present invention;

### DESCRIPTION OF THE PREFERRED EMBODIMENTS

Embodiments according to the present invention will be described below mainly on PDPs, with reference to the following views, formulae, examples, etc. It is to be understood that these views, formulae, examples, etc., plus the explanation below are for the purpose of illustrating the present invention, and do not limit the scope of the present invention. Also, the present invention can be applied to protrusions in general and is not limited to display panels such as PDPs. It goes without saying that other embodiments should also be included in the category of the present invention as long as they conform to the gist of the present invention. In the drawings, the same numerals may refer to the same elements.

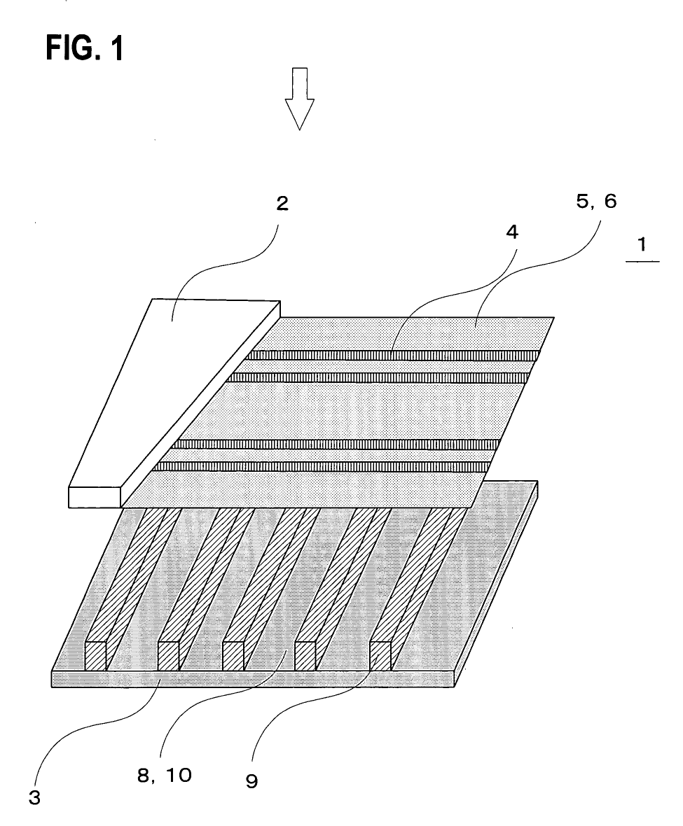

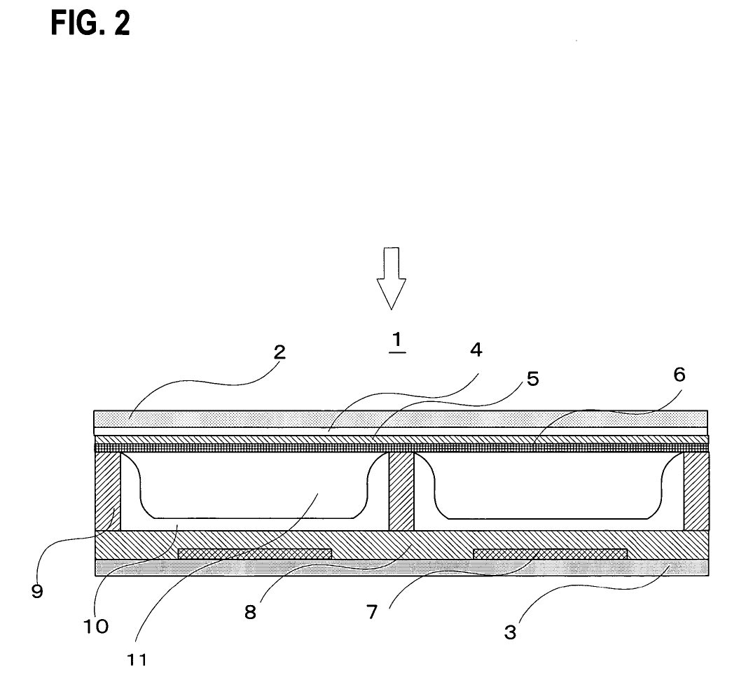

FIG. 1 is an exploded view of an example of a conventional DPD. FIG. 2 is a side cross-sectional view thereof. In FIGS. 1 and 2, the panel is watched in the direction along the arrow. PDP 1 has a structure in which a front surface side substrate 2 and a rear surface side substrate 3 face each other. In this example, on the inner side surface of the front surface side substrate 2 (the side facing the rear surface side substrate 3), display electrodes 4, a dielectric layer 5 and a protective layer 6 for protecting electrodes are sequentially layered. On the inner side surface of the rear surface side substrate 3 (the side facing the front surface side substrate 2), address electrodes 7 that extend in the direction perpendicular to the display electrodes and a dielectric layer 8 are sequentially layered, over which partitioning walls (ribs) 9 and phosphor layers 10 for red, green and blue colors are placed. The dielectric layer 8 may not be installed in the case of a system in which electric discharge is caused by applying voltage between the pairs of display electrodes as shown in FIG. 1.

An ultraviolet ray-emitting gas such as a neon gas and xenone gas is sealed in the electric discharge spaces 11 enclosed by the dielectric layer 5, partitioning walls 9, and phosphor layer 10. In PDP 1, display in visible rays is realized by applying voltage between pairs of display electrodes to generate electric discharge, which is then used to excite the ultraviolet ray-emitting gas into a plasma state, and making phosphors in the phosphor layers 10 emit light by means of the ultraviolet rays that are generated when the gas returns from the plasma state to the original state.

Color filters, electromagnetic wave shielding sheets, antireflection films, etc. are also often installed In PDPs. Gas discharge panel display devices such as large-size television sets (plasma television sets) are obtained, by installing interfaces on the PDPs that are connected with power sources and tuner units.

According to one aspect of the method for manufacturing protrusions according to the present invention, protrusions are manufactured, for example in a structure such as described above, by the steps comprising: attaching closely to a substrate one side of a mask on which a multitude of elongated slits are formed; filling a composition comprising a photosensitive resin and a lead-free glass powder into the slits by means of a squeegee printing method; curing the photosensitive resin by light exposure to make a cured composition from the composition; removing the mask; and firing the cured composition adhered to the substrate. It is to be noted hereupon that the phrase “attaching closely to a substrate” means “attaching closely to the surface of a layer on or over the substrate on which protrusions are to be installed, when there is another layer on the substrate. For example, when the substrate is a glass substrate with electrodes that has an underlayer, address electrodes and dielectric layer thereon, and the protrusions are installed on the surface of the dielectric layer, it means that the close attaching is made onto the surface of the dielectric layer.

Since the protrusions can be formed by filling only a required amount of a composition (protrusion forming material) into slits formed with the substrate and a mask, any redundant amount of the protrusion forming material is prevented from being consumed, and the material utilization efficiency is improved. Also, protrusions with a desired shape can be manufactured with good shape controlling at a low cost.

According to another aspect of the method for manufacturing protrusions according to the present invention, in a manufacturing method comprising: attaching onto a dielectric layer on a substrate a composition comprising a photosensitive resin and a lead-free glass powder; curing the resin by light exposure to make a cured composition from the composition; and firing the cured composition to form the protrusions, the protrusions are made to have a coefficient of thermal contraction by the firing of not more than 10%, a relative dielectric constant of less than 4.0 at 1 kHz and 20° C., and a difference in linear expansion coefficient of not more than 4 ppm/° C., based on the dielectric layer material.

More specifically, it is preferable, as described above, to attach closely to the dielectric layer one side of the mask on which a multitude of elongated slits are formed; fill the composition into the slits by means of a squeegee printing method; carrying out light exposure, followed by removal of the mask; and fire the cured composition adhered to the dielectric layer.

It is to be noted here that the phrase “attaching onto a dielectric layer on a substrate” means attaching a composition onto a dielectric layer that is included in a “substrate” according to the present invention in order to form protrusions on the dielectric layer.

This aspect will be explained on a case in which the protrusions are partitioning walls of a PDP according to the present invention. In a PDP having electric discharge spaces (electric discharge spaces 11 in the cases of FIGS. 1 and 2) partitioned by partitioning walls (partitioning walls 9 in the cases of FIGS. 1 and 2) installed as contacting a dielectric layer (dielectric layer 8 in the cases of FIGS. 1 and 2) on one of the substrates (rear surface side substrate 3 in the cases of FIGS. 1 and 2), the partitioning wall is prepared by using a partitioning wall forming material (that is, a composition according to the present invention), and are made to have a coefficient of thermal contraction by the firing of not more than 10%, a relative dielectric constant of less than 4.0 at 1 kHz and 20° C., and a difference in linear expansion coefficient of not more than 4 ppm/° C., based on the dielectric layer material.

When the coefficient of thermal contraction by the firing is large, the fluctuation in the height of the partitioning walls becomes large, leading to a state in which the electric discharge spaces are not sufficiently sealed. This will tend to cause failure in preventing leakage of electric discharge, making pixels emit light which should not emit light. By making the coefficient of thermal contraction not more than 10%, the shape control will be easier, precision in the production will be improved, and such a mis-operation problem will be prevented. The production yield will be improved, and the production cost will be reduced. The coefficient of thermal contraction can be measured by the ratio of the difference between the height of the partitioning walls before the firing and the height of the partitioning walls after the firing at 600° C. for one hour to the height of the partitioning walls before the firing. However, any method may be applied as long as it measures a so-called coefficient of linear contraction. It is preferable that the coefficient of linear contraction is not more than 10% in every direction of the protrusions. However, it is not an indispensable requirement, and it is often sufficient to choose a coefficient of linear contraction in a required direction according to the practice. In the case of the above-described partitioning walls, for example, the fluctuation in wall height is important. Accordingly, the coefficient of linear contraction in the direction of height is chosen.

When the relative dielectric constant of the protrusions is high, electric power consumption will be large. It will result in, for example, decrease in light, emission efficiency of PDPs. As a result of study on the light emission efficiency of PDPs, it was found that the relative dielectric constant of the protrusions (a value at 1 kHz and 20° C.) is preferably less than 4.0.

The difference in linear expansion coefficient of protrusions is important in securing the close attachment with the dielectric material lying underneath. As a result of studies on the partitioning walls of PDPs, it was found that if the difference in linear expansion coefficient based on the dielectric material is not more than 4 ppm/° C., problems of peeling-off, cracking, etc. will be restrained, and the precision in production and production yield will be improved. Since general high-strain-point glass used for glass substrates has a linear expansion coefficient of about 8 to 9 ppm/° C., it is preferable to make the linear thermal expansion coefficient of the protrusions in the range of 2 to 9 ppm/° C. so as to avoid warpage of the substrate and make the difference in linear expansion coefficient between the protrusions and the dielectric material not more than 4 ppm/° C., so as to prevent peeling-off.

It is to be noted that the relative dielectric constant and difference in linear expansion coefficient in this case are values after the firing. The values after the firing can be confirmed by model testing, without actually forming the devices. Known methods may be used for the measurement of relative dielectric constant and linear expansion coefficient. For example, in the case of relative dielectric constant, a volumetric measurement may be carried out at 1 kHz (20° C.), using a volumetric measurement apparatus 4284A from Agilent Technologies so that the relative dielectric constant can be determined from the volumes, area of the electrodes used, and film thickness. Linear expansion coefficient may be determined by measuring the length between both ends of a piece of a material while heating the material, using an optical microscope having a length-measuring function and a heat stage. Relative dielectric constant of the protrusions may be measured in any direction. However, the value of linear expansion coefficient may change according to the direction along which it is measured. In such a case, it is often sufficient, just like the coefficient of thermal contraction, to choose a linear expansion coefficient obtained along the direction needed for use, depending on the practice.

The photosensitive resin contained in the composition according to the present invention may be chosen from any known photosensitive resins. Negative-type photosensitive resins that are cured by light exposure are preferable examples.

The following explanation will be made in common on both of the above-described aspects, unless otherwise noted. Concrete examples of the negative-type photosensitive resin are siloxane-type photosensitive resins, epoxy-acrylate resins, urethane-acrylate resins, etc. Among them, negative-type photosensitive, tetrafunctional siloxane type resins are particularly favorable. It was found that negative-type photosensitive, tetrafunctional siloxane type resins are particularly excellent in moldability among the negative-type photosensitive, siloxane-type resins, and shape control may be realized rapidly, precisely and easily when a mold formed by a substrate and a mask is used for the formation of the protrusions. It is probably because the negative-type photosensitive, tetrafunctional siloxane type resins are excellent in transparency, and accordingly a sufficient amount of irradiating light is generally allowed to reach as deep as 150 to 200 μm, for example in the case of slits for partitioning walls of PDPs. Furthermore, they have another advantage that there is not much degradation in luminance (or brightness) when display panels are prepared. It is considered that this is because there is not much adsorbed gas left after the firing.

In addition to the disuse of redundant material as described above, the burden on the environment caused by the composition according to the present invention is small, since it is a lead-free system. Furthermore, it is possible to simplify the manufacturing process, and reduce the production cost, due to the facts that the composition according to the present invention is not wasted, that the curing reaction proceeds quickly by the use of the negative-type photosensitive, tetrafunctional siloxane type resin, and that the shape control is easily achieved by employing a mold formed by a substrate and a mask, as described above.

Furthermore, while the conventional pastes of partitioning wall forming material for PDPs use organic binders such as acryl compounds which are a factor of increasing the coefficient of thermal contraction by the firing, it is easily realized to make the coefficient of thermal contraction by the firing not more than 10%, by using a negative-type photosensitive, tetrafunctional siloxane type resin which has a smaller amount of components which dissipate during the firing. It was found that this reduces the fluctuation of height of the partitioning walls.

In the above description, “elongated” typically means rectangular. However, zigzagging such as a hexagonal pattern shape and meandering is also included in the “elongated” shape. The protrusions according to the present invention have an “elongated” shape, reflecting such a slit shape. There is no particular limitation to the cross-sectional shape. Partitioning walls of PDPs have a generally rectangular cross-section.

The composition according to the present invention comprising a photosensitive resin and a lead-free glass powder is preferably in the form of past so that a squeegee printing method can be applied. Besides the photosensitive resin and lead-free glass powder according to the present invention, it usually comprises a solvent, and sometimes comprises a catalyst, filler, etc. Negative-type photosensitive resins other than the negative-type photosensitive, tetrafunctional siloxane type resin may be present together, when the negative-type photosensitive, tetrafunctional siloxane type resin is used. There is no particular limitation to the compositional ratios of respective components in the composition according to the present invention, and the ratio can be arbitrarily defined. When a filler is included, the amount of the negative-type photosensitive, tetrafunctional siloxane type resin may be 5 to 30 parts by weight, and preferably 10 to 20 parts by weight; the amount of the lead-free glass powder may be 1-100 parts by weight, and preferably 20 to 60 parts by weight; and the amount of the sensitizer may be 0.05 to 15 parts by weight, and preferably 0.1 to 10 parts by weight, all based on 100 parts by weight of the filler.

Conventional glass powders that are partitioning wall forming materials for PDPs generally contains a large amount of components such as Bi₂O₃, PbO, Al₂O₃, etc., and indicate a high dielectric constant. For example, the dielectric constant value will be about 10 at 1 kHz and 20° C. Among these components, lead compounds are particularly widely used, since it can decrease the melting point of the glass.

To compare, lead-free glass powders are used in the present invention. The environmental problem by the use of lead can be avoided accordingly. It goes without saying that it is preferable that the partitioning wall forming material does not contain any lead-containing glass powder or, if it contains, the amount is as small as does not pose any substantial burden to the environment. Furthermore, ceramic particles such as silica (spherical silica, for example) having a particle size larger than those of low melting point glass powders may be used as the fillers.

Examples of the lead-free glass powder according to the present invention are powders of SiO₂/B₂O₃/ZnO systems, Bi₂O₃/SiO₂/B₂O₃ systems, etc. A powder of R₂O (wherein R=Li, Na, K or the like), BaO, CaO, MgO, TiO₂, ZrO₂, Al₂O₃, NaF, P₂O₅, or the like may be added to the powders. It is preferable that the lead-free glass powders have a softening point of 600 to 615° C., or below, since it is easy to carry out the subsequent firing.

There is no particular limitation to the size of the lead-free glass powders. In terms of handling, it is preferable that the average particle size is in the range of 1 to 10 μm. It is to be noted here, that the expression of the oxides here as well as in the following does not necessarily indicate the real composition of the lead-free glass powders. Also, their amounts expressed here as well as in the following are oxide-converted values based on the concentrations of respective chemical elements in the lead-free glass powders.

It is preferable that SiO₂ is contained in the range of 3 to 60 wt. % in a lead-free glass powder. When it is less than 3 wt. %, the compactness, strength or stability of the glass layer would be degraded. Furthermore, the thermal expansion coefficient would be out of the desired range, often causing mismatching with the glass substrate. When it is not more than 60 wt. %, the thermal softening point becomes low, and sufficient attaching to the glass substrate by firing becomes possible.

When B₂O₃ is formulated in the range of 5 to 50 wt. % in a lead-free glass powder, the electric, mechanical and thermal properties may be improved, including electric insulating properties, strength, thermal expansion coefficient, and compactness of the dielectric layer. When it exceeds 50 wt. %, the acid resistance of the glass is reduced.

The lead-free glass powders may contain 3 to 20 wt. % of at least one of the group consisting of Li₂O, Na₂O and K₂O. Regarding the alkali metal oxides such as Li₂O, Na₂O and K₂O, the storing stability of a paste (composition according to the present invention; same in the following) can be improved by making their amount not more than 20 wt. %, preferably not more than 15 wt. %, on the oxide-conversion basis. Firing at a low temperature is also possible, since it can decrease the glass transition temperature and glass softening temperature.

As a glass powder composition comprising Li, it is preferable to have

| | |
|---|---|
| Li₂O | from 2 to 15 wt. %, |
| SiO₂ | from 15 to 50 wt. %, |
| B₂O₃ | from 15 to 40 wt. %, |
| BaO | from 2 to 15 wt. %, and |
| Al₂O₃ | from 6 to 25 wt. %, |

on the oxide-conversion basis.

In the above-described composition, Na or K may be used instead of Li. However, Li is preferable from the viewpoint of stability of the paste.

Furthermore, it is possible to obtain a photosensitive glass paste from which protrusions can be formed on a glass substrate through a firing at a low temperature, by having a lead-free glass powder comprise 5 to 50 wt. % of at least one of Bi₂O₃ and ZnO. Over 50 wt. %, the allowable temperature limit of the glass becomes too low, and the firing onto the glass substrate becomes difficult. Particularly, use of glass powders containing 5 to 50 wt. % of Bi₂O₃ will provide pastes with an advantage of long pot life, etc.

As a glass powder composition comprising Bi₂O₃, it is preferable to have

| | |
|---|---|
| Bi₂O₃ | from 10 to 40 wt. %, |
| SiO₂ | from 3 to 50 wt. %, |
| B₂O₃ | from 10 to 40 wt. %, |
| BaO | from 8 to 20 wt. %, and |
| Al₂O₃ | from 10 to 30 wt. %, |

on the oxide-conversion basis.

Glass powders that contain metal oxides such as Bi₂O₃ and ZnO as well as alkali metal oxides such as Li₂O, Na₂O and K₂O, make it easier to control the thermal softening temperature and linear thermal expansion coefficient with a less alkali metal content in the glass powder.

Furthermore, while addition of Al₂O₃, BaO, CaO, MgO, ZnO, ZrO, or the like, especially Al₂O₃, BaO, or ZnO, in the glass powder can improve the hardness and/or processability, the content is preferably not more than 40 wt. % when the control of the thermal softening temperature, thermal expansion coefficient and/or refractive index is considered. The content is more preferably not more than 25 wt. %

The combined amount of a glass powder and filler used for the present invention is preferably in the range of 65 to 85 wt. % based on the sum of the glass powder, filler, negative-type photosensitive, tetrafunctional siloxane type resin, and the other organic components contained in the composition according to the present invention. If it is less than 65 wt. %, the coefficient of contraction at the firing becomes large, tending to cause cracking and/or peeling-off of the protrusions. Also loss of a large amount of organic components by firing will cause undesirable effects. Furthermore, thinning of the pattern and/or the occurrence of remained film at the development due to the organic components tends to come about. Over 85 wt. %, pattern formation properties will be deteriorated due to the scarcity of the photosensitive component.

Glasses used as dielectric materials have a refractive index of about 1.5 to 1.9, in general. If the average refractive index of the negative-type photosensitive, tetrafunctional siloxane type resin and the other organic components contained in the composition according to the present invention is greatly different from that of the glass powder, reflection/scattering of light at the interface with the glass powder will become large, preventing formation of fine patterns.

Since negative-type photosensitive, tetrafunctional siloxane type resins and the other organic components have a refractive index of 1.45 to 1.7, in order to improve the pattern forming properties, it is preferable to make the glass powder have an average refractive index of 1.5 to 1.65 so that the average refractive index is adjusted to their refractive indices.

By using a glass powder containing 2 to 10 wt. % in total of alkali metal oxides such as Li₂O, Na₂O and K₂O, not only the thermal softening temperature and thermal expansion coefficient will be easily controlled, but also the difference between the refractive index of the glass powder and the refractive index of the organic components will be easily made smaller, since the average refractive index of the glass powder can be decreased. When the content is less than 2 wt. %, the thermal softening temperature will be difficult to control. Over 10 wt. %, the luminance will be decreased owing to evaporation of the alkali metal oxides at the electric discharging. The content of the alkali metal oxides to be added is preferably less than 10 wt. %, and more preferably not more than 8 wt. %. This is also so to increase the stability of paste.

In particular, use of Li₂O can relatively increase the paste stability among alkali metal compounds. Use of K₂O provides an advantage that the refractive index may be controlled by addition of a relatively small amount. Accordingly, addition of Li₂O and/or K₂O is effective among the alkali metal oxides.

As a result, the glass powder will have a thermal softening temperature that makes its firing onto a glass substrate possible, and an average refractive index in the range of 1.5 to 1.65, easily realizing a small refractive index difference.

The refractive index measurement of the glass powder according to the present invention gives a precise value for ascertaining the effect when it is done with a light having a wavelength used for the actual light exposure. Measurement with a light having a wavelength in the range of 350 to 650 nm is particularly preferable. The refractive index measurement with the i-line (365 nm) or g-line (436 nm) is still more preferable.

It is to be noted here that the average refractive index of “the negative-type photosensitive, tetrafunctional siloxane type resin and the other organic components contained in the composition according to the present invention” means a refractive index in the state of a mixture of these components in the paste at the time of subjecting the photosensitive components to light exposure. That is, it is a refractive index of the organic components in the paste after the drying step, when light exposure is to be carried out after the drying step which follows application of the paste. For example, the refractive index may be measured after drying at 50 to 100° C. for 1 to 30 minutes which follows application of the paste onto a glass substrate. It is to be noted that the refractive index is not measured on the real paste, and the paste for the purpose is one which is composed only of “the negative-type photosensitive, tetrafunctional siloxane type resin and the other organic components contained in the composition according to the present invention” that does not contain any other components.

The generally used ellipsometric method and V block method are preferable for the refractive index measurement, and the measurement with a light having a wavelength at the time of light exposure gives precise data for ascertaining the effect. Measurement with a light having a wavelength in the range of 350 to 650 nm is particularly preferable. The refractive index measurement with the i-line (365 nm) or g-line (436 nm) is still more preferable.

Fillers may be used together with the lead-free glass powder in the composition according to the present invention. As a filler, those used conventionally may be used. For example, silica, high melting point glasses having a thermal softening temperature of not less than 600° C., ceramics, etc. may be used. To be concrete, silica, boron oxide, aluminum oxide, barium oxide, etc. are enumerated. Among them, silica is preferable from the viewpoint of consistency in quality. As a silica, spherical silica, etc. that have a larger particle size than low melting point glass powders can be used. They are preferable, since they can control the contraction at the firing. To be more concrete, commercially available pure spherical silica having an average particle size of 0.1 to 10 μm, or preferably from 1 to 5 μm, may be used.

Setting the relative dielectric constant of the protrusions (value at 1 kHz and 20° C.) to less than 4.0 is made possible by applying such a combination. Thus, it was possible to realize excellent light emitting efficiency and decrease the electric power consumption of PDPs. It was also possible to decrease the environmental burden by avoiding use of lead-containing glasses.

It was found that the peeling-off problem of the protrusions after the firing occurred when the difference in linear expansion coefficient between the protrusions and the dielectric material was over 4 ppm/° C. As a result of studies, it was found that by manufacturing the protrusions, using a composition having the negative-type photosensitive, tetrafunctional siloxane type resin, silica, and lead-free glass powders described above, and by appropriately choosing the material for the dielectric layer underneath, it was possible to keep the difference in linear expansion coefficient not more than 4 ppm/° C., thus preventing the peeling-off of the protrusions after the firing. The material for the dielectric layer underneath may be arbitrarily chosen from among known materials that satisfy the above-described difference in linear expansion coefficient. The materials include, but are not limited to, Bi₂O₃—SiO₂—Bi₂O₃ systems, for example.

The photosensitive resin according to the present invention is sometimes called a photosensitive binder resin. It is used for the purpose of maintaining the shape of the protrusions before the firing by curing them made from the composition according to the present invention. Accordingly, it is necessary that the photosensitive, tetrafunctional siloxane type resin according to the present invention is a negative-type resin that is cured by light exposure. It is to be noted that there is no particular limitation to the degree of the curing of the “cured composition” according to the present invention. It is sufficient if the shape can be maintained for the period from the time when the mask is removed to the time when the firing is carried out.

It is preferable that the negative-type photosensitive, tetrafunctional siloxane type resin according to the present invention has a structure represented by formula (1),
(SiO_{4/2})ₘ(R¹SiO_{3/2})ₙ(R²R³SiO_{2/2})ₚ(R⁴R⁵R⁶SiO_{1/2})_{q} (1)
(wherein m and q are each a positive integer; n and p are each 0 or a positive integer; and R¹ to R⁶ are, independently from each other, hydrogen or an organic group that may be bound to Si in which not all of R¹ to R⁶ are hydrogen). While this resin may have a cross-linked structure, it is preferably soluble or dispersible in a solvent in terms of the ease of handling.

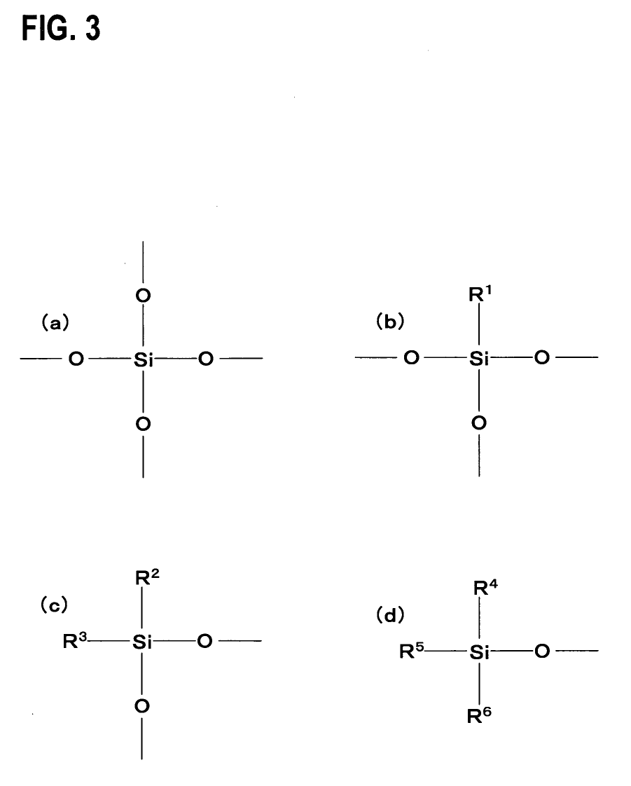

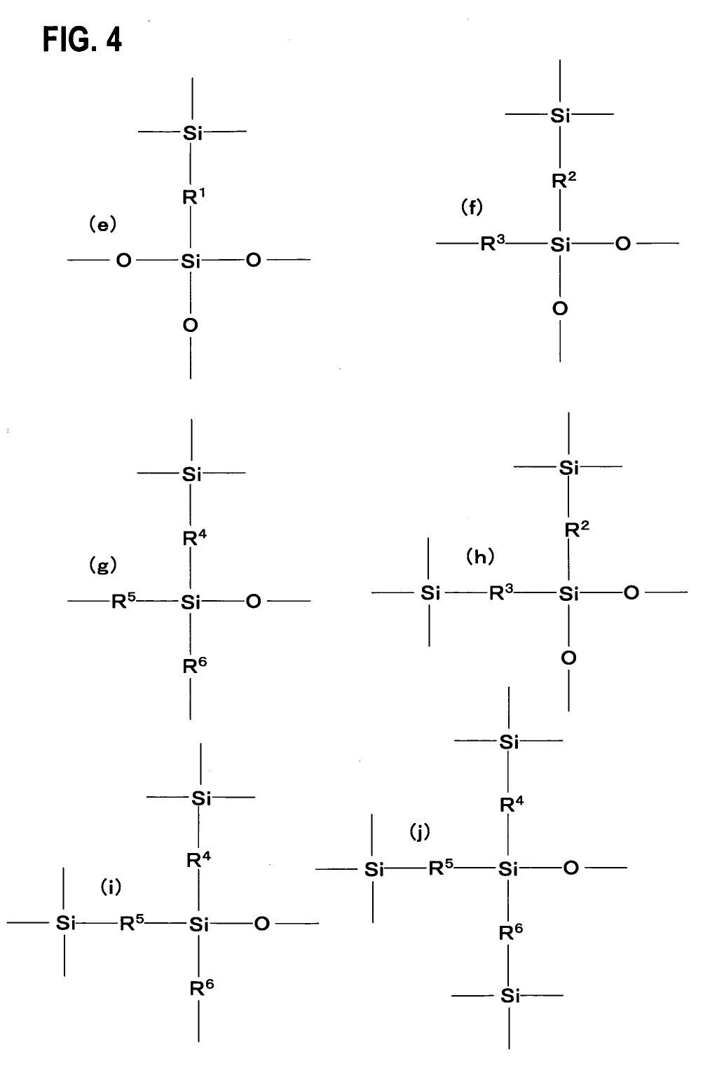

In the structure represented by formula (1), bonds shown as examples in FIGS. 3 and 4 are included. In FIGS. 3 and 4, (a)-(d) exemplify those in which R¹-R⁶ are monovalent organic groups, and (e)-(j) exemplify those in which R¹-R⁶ are divalent organic groups. Hereupon, it is to be noted that the “organic group that may be bound to Si” according to the present invention means two Si's are bound to each other with an organic group or groups in between, without having an adjacently intervening O, as shown in (e)-(j), not only in formula (1) but also in other formulae.

The molecular weight of the negative-type photosensitive, tetrafunctional siloxane type resin according to the present invention is preferably in the range of 1,000-100,000, from the viewpoint of securing the solubility into a solvent and transparency in the solvent.

While the negative-type photosensitive, tetrafunctional siloxane type resin according to the present invention may have a structure other than that represented by formula (1), it is preferable that the resin is mainly composed of the structure represented by the above-defined formula (1). To be concrete, it is preferable that not less than 90% of the resin is composed of the structure represented by the above-defined formula (1) on the molecular basis. It is more preferable that not less than 95% of the resin is composed of the structure represented by the above-defined formula (1) on the molecular basis.

Such a negative-type photosensitive, tetrafunctional siloxane type resin can be obtained from polymerization of siloxane monomers or oligomers having structures of (SiO_{4/2}), (R¹SiO_{3/2}), (R²R³SiO_{2/2}), and (R⁴R⁵R⁶SiO_{1/2}). R¹ to R⁶ in this case have the same meanings as R¹ to R⁶ in formula (1) Methods in which a monohalogenosilane is subjected to silylation of a polymer that has been formed beforehand, may also be employed.

There is no particular limitation to the above-described organic group, and a favorable resin may be appropriately selected from among the negative-type photosensitive, tetrafunctional siloxane type resins obtained by known methods such as the above-described polymerizations. Examples of such an organic group are aliphatic hydrocarbon groups that may have a substituent group, alicyclic hydrocarbon groups that may have a substituent group, aromatic hydrocarbon-containing groups that may have a substituent group, etc. The organic group preferably comprises an aromatic hydrocarbon-containing group. More preferably, the aromatic hydrocarbon-containing group comprises a structural part represented by formula (2), 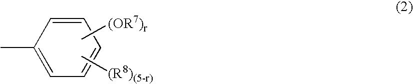
(wherein R⁷ and R⁸ are, independently from each other, hydrogen or an organic group that may be bound to Si; and r is 1 or 2).

When the aromatic hydrocarbon-containing group comprises R⁷, it is preferable that not less than 50% of R⁷ is hydrogen. Having such a structure makes it possible to enhance the solubility of the negative-type photosensitive, tetrafunctional siloxane type resin in a solvent, thus increasing the transparency of the composition according to the present invention, and allowing rapid curing of the photosensitive resin (that is curing of the curable composition) by light exposure.

As concrete examples of the above-described aromatic hydrocarbon-containing group, enumerated are groups represented by formula (3), 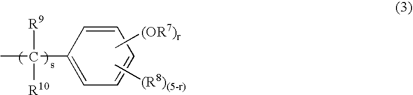
(wherein R⁷-R¹⁰ are, independently from each other, hydrogen or an organic group that may be bound to Si; r is 1 or 2; and s is an integer of 1 to 3).

It is to be noted that there is no particular limitation to the organic groups of R⁷-R¹⁰. Examples are aliphatic hydrocarbon groups that may have a substituent group, alicyclic hydrocarbon groups that may have a substituent group, aromatic hydrocarbon-containing groups that may have a substituent group, etc.

The solvent according to the present invention is used for dissolving the above-described photosensitive resin to adjust the viscosity to be suitable for the processing. Organic solvents used for this purpose include methyl cellosolve, ethyl cellosolve, butyl cellosolve, methyl ethyl ketone, dioxane, acetone, cyclohexanone, cyclopentanone, isobutyl alcohol, isopropyl alcohol, tetrahydrofuran, dimethyl sulfoxide, γ-butyrolactone, bromobenzene, chlorobenzene, dibromobenzene, dichlorobenzene, bromobenzoinc acid, chlorobenzoinc acid, propyleneglycol dibenzoate, terpineols, butyl carbitol, etc., and an organic solvent mixture containing at least one of them. To be concrete, those with a high boiling point are preferable. γ-butyrolactone, propyleneglycol dibenzoate, terpineols, butyl carbitol, etc. are examples.

It is preferable that the composition according to the present invention comprises a solvent so that 0.5 to 10 wt. % of the solvent is present in the composition at the light exposure. The transmission of the irradiating light tends to be lowered, if the solvent is less than the range. It is sometimes difficult to maintain the shape of protrusions, if the solvent is more than the range.

When filling of the composition into the slits in the method for manufacturing protrusions according to the present invention is carried out by the squeegee printing method, it is necessary to adjust, using the above-mentioned solvent, the viscosity of the protrusion forming material (that is the composition according to the present invention) for the material to be filled into the slits smoothly. It is preferable to adjust the viscosity by the amount of the solvent, and the amount of the solvent is in the range of 0.5 to 10 wt. %.

The composition according to the present invention may comprise materials for coloring the protrusions after the firing. For example, the contrast in display can be increased by coloring the protrusion black. It is possible to form a black pattern by putting from 1 to 10 wt. % of a black metal oxide into the composition. At least one type and preferably three types or more of oxides of Cr, Fe, Co, Mn, and Cu may be used as the black metal oxide. In particular, black protrusions can be formed by putting each not less than 0.5 wt. % of oxides of Fe and Mn.

Besides the black color, protrusion patterns with various colors may be formed by using pastes with inorganic pigments added that exhibit red, blue, green, and other colors.

The specific gravity of the protrusions according to the present invention is preferably in the range of 2 to 3.3. Although light weight is generally preferable, it is necessary to add a large amount of alkali metal oxides such as sodium oxide and potassium oxide in the glass material in order to achieve the specific gravity of less than 2. This will cause evaporation during the discharging, and results in undesirable decrease in discharging properties. The value over 3.3 is undesirable, since large-screen displays become heavier, and their own weights sometimes bring about distortion of the substrate.

The composition according to the present invention may further comprise additive components including at least one type of photosensitive component selected from the group consisting of photosensitive monomers, photosensitive oligomers and photosensitive polymers, other binders, photopolymerization initiators, ultraviolet ray absorbents, anti-gelling agents, sensitizers, sensitizing adjuvants, polymerization inhibitors, plasticizers, thickeners, antioxidants, dispersants, antifoaming agents, and organic or inorganic anti-precipitation agents. The above-described term “the other organic components contained in the composition according to the present invention” consists of the organic components among these materials and the organic solvent.

High aspect ratio, high fineness, and high resolution can be realized by addition of compounds having a high efficiency in ultraviolet ray absorption. As ultraviolet ray absorbents, those composed of organic dyes, particularly organic dyes having a high UV absorption coefficient in the wavelength range of 350 to 450 nm are preferably used. To be concrete, azo dyes, xanthene dyes, quinoline dyes, aminoketone dyes, anthraquinone dyes, benzophenone dyes, diphenylcyanoacrylate dyes, triazine dyes, p-aminobenzoic acid dyes, etc. may be used.

Organic dyes are also preferable when used in the capacity of light absorbents, since they do not remain in the dielectric layer after the firing, and accordingly, do not lower the properties of the dielectric layer by the presence of the light absorbents. Among them, azo-type dyes and benzophenone-type dyes are preferable. The amount of the organic dyes to be added is preferably in the range of 0.05 to 1 part by weight based on 100 parts by weight of the glass powder. The effect of an added UV ray absorbent is decreased when the amount is less than 0.05 parts by weight. The amount over 1 part by weight is often undesirable, since the properties of the dielectric layer after the firing is degraded. It is more preferably in the range of 0.1 to 0.18 parts by weight.

Examples of methods for adding ultraviolet ray absorbents composed of organic dyes include one in which a solution in which organic dyes are dissolved in an organic solvent is prepared beforehand, and the solution is mixed during the process of preparing the paste, and one in which a glass powder is mixed into the organic solution, followed by drying. In this method, a so-called capsule-type powder in which the surface of each particle of the glass powder is coated with an organic film, can be prepared.

Regarding the present invention, there are occasions in which metals and oxides of Fe, Cd, Mn, Co, Mg, etc. contained in the glass powder react with the photosensitive components present in the paste, and cause the paste to gel in a short time, making the coating impossible. It is preferable to add anti-gelling agents to prevent such a reaction.

As an anti-gelling agent, triazole compounds are preferably used. Benzotriazole and its derivatives are preferably used as a triazole compound. Among them, benzotriazole is particularly effective.

According to one example of the surface treatment of a glass powder by benzotriazole for use in the present invention, a specific amount of benzotriazole is dissolved into an organic solvent such as methyl acetate, ethyl acetate, ethyl alcohol, methyl alcohol or the like, followed by immersion of the glass powder in this solution for 1 to 24 hours. After the immersion, it was dried, preferably, naturally at 20 to 30° C. to evaporate the organic solvent to obtain the glass powder which is triazole-treated.

The ratio of the amount of the anti-gelling agent for use (anti-gelling agent/glass powder) is preferably in the range of 0.05 to 5 parts by weight/100 parts by weight.

The sensitizer is added for the purpose of improving the sensitivity. Concrete examples are 2,4-diethyl thioxantone, isopropyl thioxantone, 2,3-bis(4-diethylaminobenzal)cyclopentanone, 2,6-bis(4-dimethylaminobezal)cyclohexanone, 2,6-bis(4-dimethylaminobezal)-4-methylcyclohexanone, Micheler's ketone, 4,4-bis(diethylamino)benzophenone, 4,4-bis(dimethylamino)chalcone, 4,4-bis(diethylamino)chalcone, p-dimethylaminocinamylideneindanone, p-dimethylaminobenzylideneindanone, 2-(p-dimethylaminophenylvinylene)-isonaphthothiazole, 1,3-bis(4-dimethylaminobenzal)acetone, 1,3-carbonyl-bis(4-diethylaminobenzal)acetone, 3,3-carbonyl-bis(7-diethylaminocoumarin), N-phenyl-N-ethylethanolamine, N-phenylethanolamine, N-tolyldiethanolamine, isoamyl dimethylaminobenzoate, isoamyl diethylaminobenzoate, 3-phenyl-5-benzoylthiotetrazole, 1-phenyl-5-ethoxycarbonylthiotetrazole, etc. One or more of them may be used in the present invention. It is to be noted that some sensitizers may also be used as photopolymerization initiators.

Sensitizers having a light absorbing ability in the wavelength ranges for the light exposure are used. It is to be noted, in this case, that it is possible to increase the refractive index of the organic components by adding a large amount of such a sensitizer, since the refractive index becomes extremely high in the vicinity of the absorbed wavelengths.

When a sensitizer is added to the protrusion forming material according to the present invention, the amount to be added is usually in the range of 0.05 to 15 parts by weight, or preferably in the range of 0.1 to 10 parts by weight, based on 100 parts by weight of the filler. If the amount of the sensitizer is too small, its effect of improving the luminosity sensitivity will not be exhibited. If the amount of the sensitizer is too large, the ratio of remaining materials in the exposed parts may be too small. Here, in the present invention, the “photosensitive component” means a negative-type photosensitive, tetrafunctional siloxane type resin. However, when other photosensitive monomers, photosensitive oligomers and/or photosensitive polymers are also included, it means photosensitive components including these.

A polymerization inhibitor is added to improve the thermal stability at the storing. Concrete examples of a polymerization inhibitor are hydroquinone, monoesters of hydroquinone, N-nitrosodiphenylamine, phenothiazine, p-t-butyl catechol, N-phenylnaphthylamine, 2,6-di-t-butyl-p-methylphenol, chloranil, pyrogallol, etc. When a polymerization inhibitor is added, the amount is usually in the range of 0.001 to 1 part by weight, based on 100 parts by weight of the photosensitive component.

As concrete examples of a plasticizer, enumerated are dibutyl phthalate, dioctyl phthalate, polyethylene glycol, glycerin, etc.

Any known mask may be used as a mask for use in the present invention, as long as it can be used for light exposure with active energy rays such as ultraviolet rays in the manufacture of electronic parts or electronic products. Metal masks of stainless steel, brass, nickel molybdenum steel, etc. may be enumerated as the examples. Man-made resins may also be used as a material for the mask.

The squeegee printing method according to the present invention means that a protrusion forming material is filled into slits for filling with a metal blade, a rubber blade or the like.

Methods that are usually applied in the manufacturing of electronic parts or electronic products may be used for firing the cured products adhered to the substrates. For example, they are transferred into a furnace, where they are fired at from 500 to 600° C. that is a temperature at which the lead-free glass powder for use is sintered.

The composition according to the present invention is usually in the form of a paste, and can be prepared by mixing and dispersing respective components uniformly with three-roller kneader. The viscosity of the paste is appropriately adjusted by the ratio of the amount of each component to be added. The range may be between 2,000 to 200,000 cps (centipoise). It is preferably in the range of 200 to 5,000 cps, when the coating onto a substrate is carried out by a spin coating method, for example. It is preferably in the range of 50,000 to 200,000 cps in order to obtain a film thickness of 10 to 20 μm by one coating of a screen printing method. In the case of squeezing printing, it is preferably in the range of 50,000 to 200,000 cps.

An example in which the pattern processing is carried out using the composition according to the present invention will be described in the following. However, the present invention is not limited to the example. The composition according to the present invention is applied onto the whole or part of a glass or ceramic substrate. Or, the composition according to the present invention may be applied onto the whole or part of a polymer film, and transferred to a glass or ceramic substrate.

Methods such as a screen printing method, bar coater method, roll coater method, die coater method, squeegee printing method, etc. may be used as the coating method. Squeegee printing method is particularly preferable, since it is excellent in material utilization efficiency, does not require development, and the shape control is easy. Besides the squeegee printing, a photosensitive glass paste method that can form a fine pattern with only a few steps, may be employed. The photosensitive glass paste method is a method in which the composition is applied all over the dielectric layer, a photomask pattern is printed thereon by light exposure, a protrusion pattern is formed by development, and then, the protrusions are formed by firing. Active energy rays such as ultraviolet rays may be used for the light exposure. It is to be noted that the coating thickness can be adjusted by choosing a coating method, viscosity of the paste and/or the like.

When the paste is applied onto a substrate, a surface treatment may be carried out on the substrate to enhance the adhesion between the substrate and the coating film.

For the surface treating solution, enumerated are silane coupling agents such as vinyltrichlorosilane, vinyltrimethoxysilane, vinyltriethoxysilane, tris-(2-methoxyethoxy)vinylsilane, γ-glycidoxypropyltrimethoxysilane, γ-(methacryloxypropyl)trimethoxysilane, γ-(2-aminoethyl)aminopropyltrimethoxysilane, γ-chloropropyltrimethoxysilane, γ-mercaptopropyltrimethoxysilane, and γ-aminopropyltriethoxysilane; and organic metal compounds such as organotitanium compounds, organoaluminum compounds, and organozirconium compounds.

A silane coupling agent or an organic metal compound is diluted with an organic solvent such as ethylene glycol monomethyl ether, ethylene glycol monoethyl ether, methyl alcohol, ethyl alcohol, propyl alcohol or butyl alcohol, to a concentration in the range of 0.1 to 5 wt. % for use. Then, the surface treating solution is applied onto a substrate uniformly with a spinner or the like, followed by drying at 80 to 140° C. for 10 to 60 minutes to complete the surface treatment. When it is applied onto the afore-mentioned polymer film to transfer it onto the glass or ceramic substrate, processes similar to those used for general-type dry film resists may be applicable, by carrying out the drying while it is on the film, sticking it onto the glass or ceramic substrate, and then carrying out light exposure.

Light exposure is carried out using an exposure apparatus after the application of the paste. Light exposure using a photomask is a general procedure, as is carried out in the usual photolithography. Negative type or positive type masks are chosen, depending on the type of the photosensitive resin. Methods in which shapes are directly formed with electronic beams, red or blue laser beams, or the like without using a photomask may also be applied. In the case of the squeegee method, masks according to the present invention are used. Stepper exposure apparatuses, proximity exposure apparatuses, etc. may be used as the exposure apparatus. When large-area exposure is necessary, it is possible to carry out exposing the large area with an exposure apparatus for a small exposure area, by carrying out the exposure while transporting a substrate such as a glass substrate after the coating of the substrate with the composition.

The source of active energy rays used in this occasion may be determined depending on the photosensitive resin for use. For example, visible rays, near-ultraviolet rays, ultraviolet rays, electronic beams, X rays, laser rays, etc. are enumerated as the light source. Among them, ultraviolet rays are preferable, and low-pressure mercury lamps, high-pressure mercury lamps, superhigh-pressure mercury lamps, halogen lamps, sterilization lamps, etc. may be used as light sources. Among them, superhigh-pressure mercury lamps are preferable. The light exposure conditions differ according to the coating thickness, but the light exposure is carried out usually for 20 seconds to 30 minutes, using a superhigh-pressure mercury lamp with an output of 1 to 100 mW/cm². Also, electronic beams and visible rays with wavelengths longer than those of ultraviolet rays are sometimes preferable.

It is possible to improve the pattern shape, by installing an oxygen shielding film on the surface of the applied composition. Examples of the oxygen shielding film are films of polyvinyl alcohol (PVA), cellulose and polyester, etc.

Formation of a PVA film is carried out by uniformly applying a 0.5 to 5 wt. % aqueous solution onto a substrate with a spinner or the like, and then drying it at 70 to 90° C. for 10 to 60 minutes to evaporate the water contained. Addition of a small amount of alcohol to the aqueous solution is also preferable, since the coating ability onto a dielectric film is improved and evaporation is made easier. A more preferable PVA content in the solution is 1 to 3 wt. %. When in this range, the sensitivity may be further improved and the pattern shape may be improved.

The following reason is presumed for the improvement of sensitivity by the application of PVA. That is, while oxygen in the air degrades the sensitivity of photocuring when the photosensitive components are subjected to photoreaction, the PVA film can shield the components from the obstructive oxygen, thus improving the sensitivity at the light exposure.

When a transparent film such as polyester, polypropylene or polyethylene is used, there are methods in which such a film is stuck onto the applied composition for use.

When development is necessary after the light exposure, it is carried out by utilizing the solubility difference between the exposed parts and the unexposed parts in the developing solution. Immersion methods, showering methods, spray methods and brushing methods are applicable for the purpose.

When the development is necessary, organic solvents into which the organic components in the composition can be dissolved may be used as a developing solution. Water may be added to the solution as long as the dissolution power of the organic solvent is not lost.

The development can be carried out with a basic aqueous solution, when compounds having acidic groups such as carboxylic groups are present in the composition. While aqueous solutions of alkali metals such as sodium hydroxide, sodium carbonate and calcium hydroxide may be used as the basic aqueous solution, aqueous organic basic solutions are preferable since the basic components are easily removed at the firing. Amine compounds may be used as a basic organic compound. To be concrete, tetramethylammonium hydroxide, trimethylbenzylammonium hydroxide, monoethanolamine, diethanolamine, etc. are enumerated.

The concentration of the basic aqueous solution is generally in the range of 0.01 to 10 wt. %, and preferably 0.1 to 5 wt. %. When it is too low, the parts to be dissolved cannot be removed, and a too high concentration may cause undesirable effects: the patterned parts may be peeled off, and the parts that should not be dissolved may be eroded. It is preferable to carry out the development at 20 to 50° C. from the viewpoint of the process control.

Next, firing is carried out in a firing furnace. The firing atmosphere and temperature vary according to the types of pastes and substrates. It is carried out in the air, or in an atmosphere of nitrogen, hydrogen or the like. Batch-type firing furnaces and belt-carrying, continuous firing furnaces may be used as the furnace. When the pattern processing is carried out on a glass substrate, it is preferable to fire at a maximum temperature of 450 to 620° C. for 10 to 120 minutes.

When carrying out the firing, it is to be noted that it is important to optimize the profiles to raise and lower the temperature to and from the maximum temperature according to the material composition, so that the coefficient of contraction does not exceed 10%, and no peeling-off occurs. A heating process at 50 to 300° C. for the purpose of drying and/or preliminary reactions may also be introduced in the above-described respective steps of coating, light exposure, development and firing.

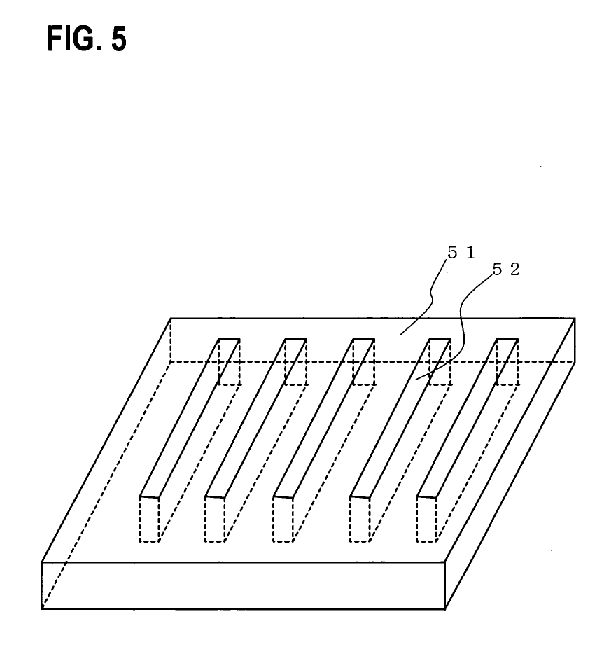

In the following, the present invention is described in detail, using drawings, and for cases in which the protrusions according to the present invention are partitioning walls of a PDP. FIG. 5 is a schematic perspective view showing a mask in order to explain the method for manufacturing protrusions (that is, partitioning walls), for a case in which the protrusions according to the present invention are partitioning walls of a PDP. In this example, the mask 51 for use in the method for manufacturing the partitioning walls is a thin flat metal mask.

On the mask 51, formed are elongated slits 52 in the shape of partitioning walls that pass through from one side to the other side of the mask. Since the composition for use shrinks by dissipation of the solvent, light exposure, firing, etc. which occur later, the shape of slits in the mask is determined, taking into consideration the coefficient of contraction for the dimensions of the partitioning walls to be manufactured. The composition according to the present invention is advantageous also for its small coefficient of contraction.

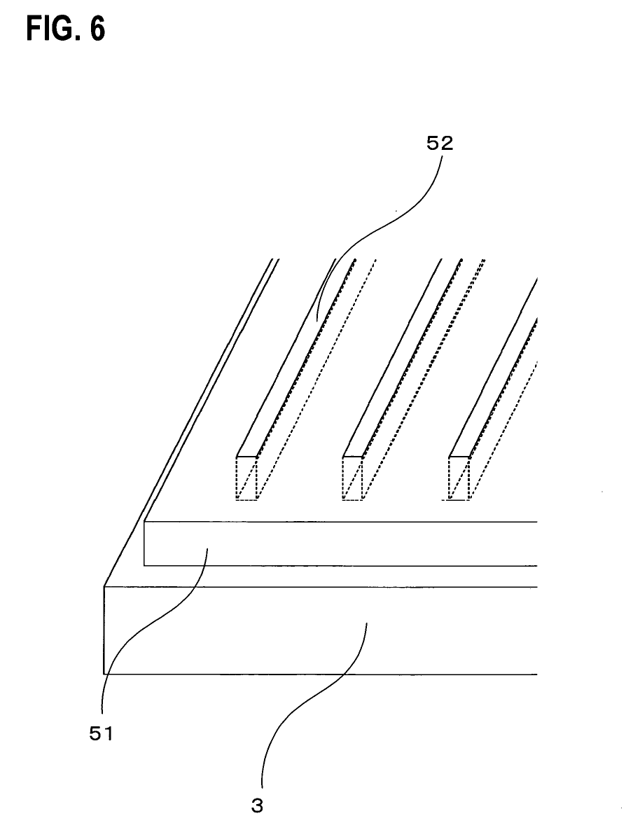

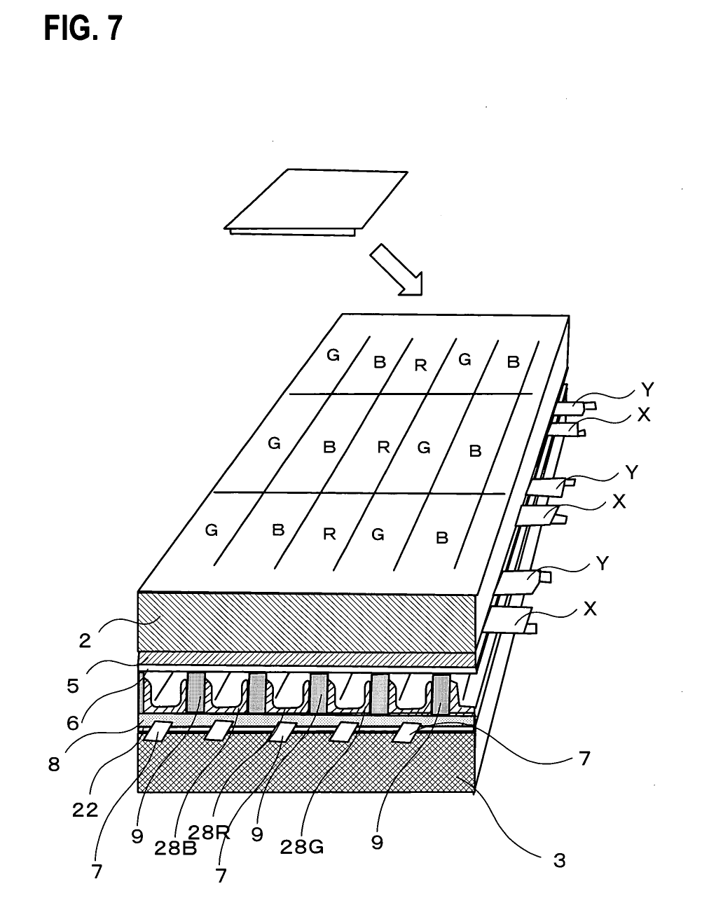

FIG. 6 is a schematic view explaining the positional relationship between the mask 51 and a substrate 3 when partitioning walls are formed on the substrate. In FIG. 6, the substrate 3 is the rear surface side glass substrate with electrodes on which an underlayer, address electrodes 7 and a dielectric layer 8 are formed sequentially as shown in FIG. 7. When the partitioning walls are being formed, the mask 51 is closely attached to the surface of the substrate with electrodes 3 (the surface of the dielectric layer 8). Accordingly, the rear surface side of the slits 52 of mask 51 is blocked up by the substrate 3, and the mask 51 and substrate 3 with electrodes serve as a mold. In FIG. 7, the underlayer 22 as well as phosphor layers 28R, 28G and 28B are also shown.

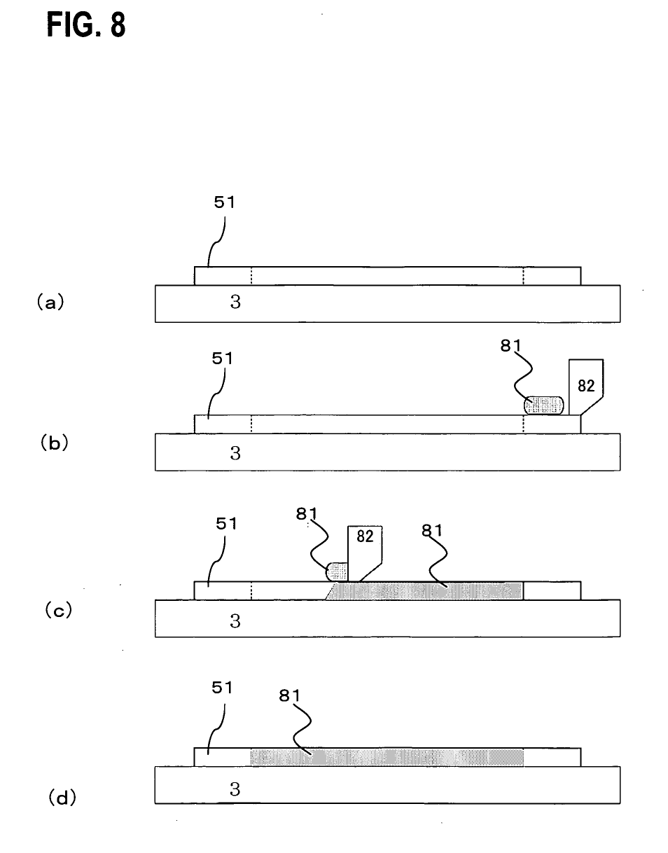

FIG. 8(a)-(d) are views explaining, in a stepwise manner, an example of the method for manufacturing partitioning walls according to the present invention. The following explanation will be made in a stepwise manner.

(a) Positional Alignment of the Substrate and Mask

First, the slits of the mask 51 are aligned to the locations on the substrate 3 on which the partitioning walls are to be formed, and the mask 51 is attached closely to the surface of substrate 3. Since this alignment must be carried out so that the partitioning walls are formed precisely between the address electrodes 7 of the substrate 3, it is preferable to put alignment marks on the substrate 3 and mask 51 beforehand, and make these marks meet each other when the mask 51 is closely attached to the substrate 3 (see FIG. 8(a)).

Next, the partitioning wall forming material 81 in a paste form (that is, the composition according to the present invention) is placed onto the mask 51 that has been aligned, and closely attached and fixed in this way. A metal blade 82 is then set (see FIG. 8(b)).

(b) Squeegee Printing Step

Squeegee printing is carried out with the paste of the partitioning wall forming material 81 on the mask 51, while the mask 51 is closely attached and fixed to the substrate 3, in order to fill the partitioning wall forming material 81 into the slits (see FIG. 8(c)).

As the partitioning wall forming material 81, a photosensitive, low melting point glass paste comprising a lead-free low melting point glass powder, filler, negative type photosensitive resin and solvent may be used. To be concrete, a ZnO powder may be used as the lead-free low melting point glass powder, and a spherical silica may be used as the filler.

It is possible to appropriately adjust the viscosity of the partitioning wall forming material 81 by choosing a proper solvent in order to make the material 81 easily filled into the slits 52 of the mask 51, and to improve the transmission properties of the irradiating light.

Thus, the partitioning wall forming material 81 is filled into the slits 52, by carrying out squeegee printing with the material 81 using the mask 51 (see FIG. 8(d)).

It is to be noted that the above-described sequence of steps may be carried out automatically by controlling the squeegee printing apparatus and holding apparatus with a controller.

Afterwards, light exposure is carried out with the mask 51 closely attached to the substrate 3 to cure the partitioning wall forming material 81. The light exposure may be carried out by irradiating the material 81 with ultraviolet rays both from the side of the substrate 3 to which the mask 51 is attached and from the other side of the substrate 3. While the irradiation for the exposure may be carried out only from the side of the substrate 3 on which the partitioning wall forming material is present, the substrate 3 is usually made of glass that transmits the irradiating light, and accordingly, the material 81 can be cured from both sides. Regarding the transmission of the irradiating light, there are address electrodes and dielectric layer formed on the substrate 3 to be considered. However, the address electrodes are formed between the partitioning walls, and do not block the exposure. Furthermore, although the dielectric layer is formed all over the inner side surface of the substrate 3, it is thinly formed, and does not pose any problem for the irradiating light to pass through.

Afterwards, the mask 51 is removed (demolded) from the substrate 3, with the partitioning wall forming material 81 in a cured state. The inner surfaces of slits 52 of the mask 51 may be surface-treated beforehand for demolding in order to ease demoldability. For this demolding treatment, silica coating, silicone coating, fluorine coating, etc. may be applied. It is to be noted that fire-proof oxides and plural resins having different glass transition points may be added to the coating agent in order to adjust various properties such as adhesion, relationship between the viscosity and the temperature, etc. Then, the partitioning wall forming material 81 on the substrate 3 is fired so that the partitioning walls are formed on the substrate 3.

Since the partitioning wall forming material 81 is filled only into the slits 52 of the mask 51 in this way, by forming the partitioning walls according to the squeegee printing method, waste of the partitioning wall forming materials is avoided, and the utilization efficiency of the partitioning wall forming material can be improved. Burden on the environment will be smaller, since the composition according to the present invention has no lead, in addition to the above-described fact that waste of the material is avoided. Furthermore, the process can be simplified and the production cost can be reduced, since the composition according to the present invention is not wasted, use of the the negative-type photosensitive, tetrafunctional siloxane type resin makes the curing reaction proceed rapidly, and a high level of shape control is made possible by employing a mold formed by the substrate and the mask, as described above.

The protrusions prepared by the above-described manufacturing methods are preferably used as partitioning walls of the above-described display panels, particularly plasma display panels. That is, partitioning wall manufacturing technologies that are excellent, compared with the conventional technologies, in some or all points of material utilization efficiency, shape control, costs, manufacturing precision affected by physical properties of materials such as thermal shrinking, process yield, electric power consumption, and impact on environment by lead, as well as gas discharge panels that are excellent, compared with the conventional technologies, in some or all points of material utilization efficiency, shape control, costs, manufacturing precision affected by physical properties of materials such as thermal shrinking, process yield, electric power consumption, and impact on environment by lead, are realized by employing the present invention.

### EXAMPLES

The following is a detailed description of an example of the present invention.

### Example 1

(Preparation of a Photosensitive Paste)

A paste obtained by kneading 60 wt. % of a spherical silica (average particle size being 2 μm), 15 wt. % of a zinc oxide type low melting point glass (average particle size being 5 μm), 10 wt. % of a siloxane type photosensitive binder (negative-type photosensitive, tetrafunctional siloxane type resin), 5 wt. % of a cross-linking agent, 5 wt. % of propyleneglycol dibenzoate (PPG-DBz), and 5 wt. % of γ-butyrolactone (GBL), was further heated to 130° C. for the viscosity adjustment to form a photosensitive paste in which the combined amount of solvents of PPG-DBz and GBL was adjusted to be 3 wt. %.

(Preparation of a Metal Mask)

A stainless steel plate having a size of 280 mm in length, 180 mm in width and 160 μm in thickness was subjected to a laser processing to form six hundred slits that were 150 mm long, and had a generally trapezoidal cross-sectional shape with an opening of 85 μm in width on the front side and 65 μm in width on the rear side of the plate, in the central part of the mask at 360 μm interval.

(Glass Substrate)

The glass substrate used was a rear surface side substrate 3 with electrodes thereon on which an underlayer, address electrodes 7 (60 μm wide at 360 μm interval) and a dielectric layer 8 were formed sequentially as shown in FIG. 7.

(Positional Alignment)

After the glass substrate was fixed on a fixing base of a printing machine with a built-in heater, the positional alignment of the glass substrate and the metal mask was carried out with a precision of ±10 μm, using the alignment marks preliminarily put on the glass substrate and the mask.

(Printing)

The glass substrate and the metal mask (inversely placed so that the width tapered away from the surface of the substrate) was heated at 80° C. with a heater of the fixing base. The photosensitive paste that had been heated also at 80° C. was fed onto them in this state, and squeegee printing was carried out at a speed of 20 mm/s using a stainless blade.

(Light Exposure)

After the printing was completed, the glass substrate and the metal mask were set on a dual-side, light exposing machine as they were fixed to each other, to allow exposure at an exposure amount of 500 mJ/cm² (i-line) so that the photosensitive paste was cured. Then, the mask was removed. The pattern had a height of 148 μm, a bottom width of 84 μm, and a top width of 65 μm.

(Firing)

In an air atmosphere, the firing was carried out while the temperature of this glass substrate was raised from room temperature to 300° C. at 10° C./min, from 300° C. to 400° C. at 3.3° C./min, from 400° C. to 600° C. at 10° C./min, held at 600° C. for 30 minutes, and then decreased from 600° C. to room temperature at 20° C./min. The pattern had a height of 136 μm (the coefficient of contraction being 8%), a bottom width of 84 μm (the coefficient of contraction being 0%), and a top width of 63 μm (the coefficient of contraction being 3%).

(Lighting Test)

The substrate thus formed was used in constructing a PDP for a lighting test, which showed a favorable result of 80% in luminance of the original value after 1,000 hours.

### Example 2

(Preparation of a Photosensitive Partitioning Wall Forming Paste)

Seven parts by weight of a negative-type photosensitive, tetrafunctional siloxane type resin, 63 parts by weight of a spherical silica having an average particle size of 1.5 μm, 16 parts by weight of a zinc oxide-type, low melting point glass powder, 5 parts by weight of organic components (cross-linking agent, polymerization initiator), and 9 parts by weight of an organic solvent mixture of propyleneglycol dibenzyl and γ-butyl lactone were mixed together and stirred until the mixture became uniform to obtain a partitioning wall forming material (composition according to the present invention).

(Measurement of Relative Dielectric Constant and Linear Expansion Coefficient)

The partitioning wall forming material prepared above, was applied by squeegee coating onto a low-resistance Si wafer (0.01 Ω·cm) to form a 100 μm-thick film which was then fired at 610° C. for 40 minutes. The thickness was measured, using a shape measuring device manufactured by Mitaka Kohki Co., Ltd. Next, a masking processing was carried out on the partitioning wall forming material, 150-nm thick platinum was deposited by vacuum sputtering, and the mask was removed to leave the electrodes. A volumetric measurement was carried out at 1, 10 and 100 kHz (20° C.) with a volumetric measurement apparatus 4284A from Agilent Technologies, and the relative dielectric constant was determined, using the volumes, area of electrodes and thickness. As a result, relative dielectric constants of 3.8 (1 kHz, 20° C.), 3.4 (10 kHz, 20° C.), and 3.2 (100 kHz, 20° C.) were obtained. As a result of measurement of the length between both ends of a piece of the material while heating and using an optical microscope having a length-measuring function and a heat stage, the linear expansion coefficient turned out to be 3.5 ppm/° C.

(Preparation and Evaluation of a Panel)

On the inner side surface of the rear surface side glass substrate 3, an underlayer, a plurality of address (for data) electrodes 7 for generating address discharging, and a dielectric layer 8 (having a linear expansion coefficient of 7 ppm/° C.) were formed sequentially, and the negative-type partitioning wall forming material prepared above, was applied onto the substrate 3 with a squeegee coating apparatus to form a film having a thickness of 150 μm, followed by prebaking in an oven at 130° C. for 60 minutes. Then, a mask pattern with a partitioning wall width of 60 μl and a pitch of 360 μm was formed by light exposure at an exposure amount of 900 mJ/cm², using an exposing machine MPA1300 from Dainippon Screen Manufacturing Co., Ltd., and post-exposure baking was carried out in an oven at 140° C. for 10 minutes.

Next, spray development was carried out with a 1 wt. % aqueous sodium hydroxide solution for 50 seconds, and then, firing was carried out at 580° C. for 1 hour in a conveyer-furnace. In this way, partitioning walls having a height of about 140 μm, a width of about 90 μm, and a relative dielectric constant of 3.8 (a value at 1 kHz and 20° C.) were formed in a stripe shape to sandwich the address electrodes 7, thus physically partitioning the electric discharges. The coefficient of thermal contraction by the firing was 7%, which was smaller than the conventional values. The coefficient of contraction was determined as a ratio of the difference between the wall height before the firing and the wall height after the firing at 600° C. for 1 hour to the wall height before the firing. It was also confirmed that the partitioning walls were not peeled off the dielectric layer.

Next, phosphor layers 10 were formed in the elongated grooves between the partitioning walls. Then, a front surface side glass substrate 2 in which display electrodes were installed on the inner side surface with a dielectric layer 5 and a protective layer 6 composed of MgO being layered thereon beforehand, was stuck onto the above-described structure with a glass paste for sealing. Afterwards, a light emitting gas was introduced to form a panel. When it was lit, it was confirmed as shown in the TABLE below that the luminance and light emitting efficiency were improved due to the partitioning walls with the low-dielectric constant, compared with the luminance and light emitting efficiency of a panel having a similar shape and prepared from a conventional lead-containing partitioning wall forming material having a relative dielectric constant of 9 (a value at 1 kHz and 20° C.). Hereupon, the relative luminance and relative light emitting efficiency are represented as the ratio on the basis that the luminance and light emitting efficiency of a panel having a similar shape and prepared from a conventional lead-containing partitioning wall forming material are each taken as 1. The luminance was measured by means of a photoprobe (Yokogawa Electric Corp., main body—3296 and light receiving section—329614), and the light emitting coefficient was calculated from the electric power consumed at the time.

TABLE

| | Relative dielectric | | |
|---|---|---|---|
| | constant of the | | Relative light |
| | partitioning walls | Relative | emitting |
| CONDITIONS | (1 kHz, 20° C.) | luminance | efficiency |
| EXAMPLE 2 | 3.8 | 1.07 | 1.04 |
| Conventional | 9 | 1 | 1 |
| conditions | | | |

What is claimed is:

1. A method for manufacturing protrusions comprising:
attaching closely to a substrate one side of a mask on which a multitude of elongated slits are formed;
filling a composition comprising a negative-type photosensitive, tetrafunctional siloxane type resin and a lead-free glass powder into said slits by means of a squeegee printing method;
curing said photosensitive resin by light exposure to make a cured composition from the composition;
removing said mask; and
firing said cured composition adhered to the substrate.

2. A method for manufacturing protrusions comprising:
attaching onto a dielectric layer on a substrate a composition comprising a photosensitive resin and a lead-free glass powder;
curing said photosensitive resin by light exposure to make a cured composition from the composition; and
firing the cured composition,
wherein the coefficient of thermal contraction by the firing of the protrusions is not more than 10%, the protrusions have a relative dielectric constant of less than 4.0 at 1 kHz and 20° C., and a difference in linear expansion coefficient of not more than 4 ppm/° C., based on the dielectric layer material.

3. A method for manufacturing protrusions according to claim 2 comprising:
attaching closely to said dielectric layer one side of a mask on which a multitude of elongated slits are formed;
filling said composition into said slits by means of a squeegee printing method;
carrying out light exposure, followed by removal of said mask; and
firing said cured composition adhered to said dielectric layer.

4. A method for manufacturing protrusions according to claim 2 wherein said composition comprises a negative-type photosensitive, tetrafunctional siloxane type resin.

5. A method for manufacturing protrusions according to claim 3 wherein said composition comprises a negative-type photosensitive, tetrafunctional siloxane type resin.

6. A method for manufacturing protrusions according to claim 2 wherein said composition further comprises silica.

7. A method for manufacturing protrusions according to claim 3 wherein said composition further comprises silica.

8. A method for manufacturing protrusions according to claim 1 wherein said negative-type photosensitive, tetrafunctional siloxane type resin has a structure represented by formula (1),
(SiO_{4/2})ₘ(R¹SiO_{3/2})ₙ(R²R³SiO_{2/2})ₚ(R⁴R⁵R⁶SiO_{1/2})_{q} (1)
(wherein m and q are each a positive integer; n and p are each 0 or a positive integer; and R¹ to R⁶ are, independently from each other, hydrogen or an organic group that may be bound to Si in which not all of R¹ to R⁶ are hydrogen).

9. A method for manufacturing protrusions according to claim 4 wherein said negative-type photosensitive, tetrafunctional siloxane type resin has a structure represented by formula (1),
(SiO_{4/2})ₘ(R¹SiO_{3/2})ₙ(R²R³SiO_{2/2})ₚ(R⁴R⁵R⁶SiO_{1/2})_{q} (1)
(wherein m and q are each a positive integer; n and p are each 0 or a positive integer; and R¹ to R⁶ are, independently from each other, hydrogen or an organic group that may be bound to Si in which not all of R¹ to R⁶ are hydrogen).

10. A method for manufacturing protrusions according to claim 5 wherein said negative-type photosensitive, tetrafunctional siloxane type resin has a structure represented by formula (1),
(SiO_{4/2})ₘ(R¹SiO_{3/2})ₙ(R²R³SiO_{2/2})ₚ(R⁴R⁵R⁶SiO_{1/2})_{q} (1)
(wherein m and q are each a positive integer; n and p are each 0 or a positive integer; and R¹ to R⁶ are, independently from each other, hydrogen or an organic group that may be bound to Si in which not all of R¹ to R⁶ are hydrogen).

11. A method for manufacturing protrusions according to claim 8, wherein said organic group comprises an aromatic hydrocarbon-containing group.

12. A method for manufacturing protrusions according to claim 9, wherein said organic group comprises an aromatic hydrocarbon-containing group.

13. A method for manufacturing protrusions according to claim 11, wherein said aromatic hydrocarbon-containing group comprises a structural part represented by formula (2), 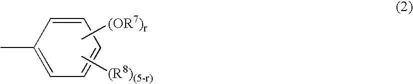
(wherein R⁷ and R⁸ are, independently from each other, hydrogen or an organic group that may be bound to Si; and r is 1 or 2).

14. A method for manufacturing protrusions according to claim 12, wherein said aromatic hydrocarbon-containing group comprises a structural part represented by formula (2), 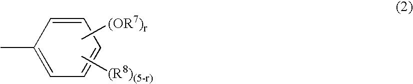
(wherein R⁷ and R⁸ are, independently from each other, hydrogen or an organic group that may be bound to Si; and r is 1 or 2).

15. A method for manufacturing protrusions according to claim 1, wherein said composition comprises a solvent so that 0.5 to 10 wt. % of said solvent is present in the composition at the light exposure.

16. A method for manufacturing protrusions according to claim 4, wherein said composition comprises a solvent so that 0.5 to 10 wt. % of said solvent is present in the composition at the light exposure.

17. A method for manufacturing protrusions according to claim 5, wherein said composition comprises a solvent so that 0.5 to 10 wt. % of said solvent is present in the composition at the light exposure.
